(19) United States
(12) Patent Application Publication
(10) Pub. No.: US 2016/0047515 A1
(43) Pub. Date: Feb. 18, 2016

(54) METHOD AND APPARATUS FOR COLLIMATING LIGHT FROM A LASER-EXCITED PHOSPHOR ELEMENT

(71) Applicant: Kevin Stone, Chandler, AZ (US)

(72) Inventor: Kevin Stone, Chandler, AZ (US)

(21) Appl. No.: 14/828,137

(22) Filed: Aug. 17, 2015

Related U.S. Application Data
(60) Provisional application No. 62/038,526, filed on Aug. 18, 2014.

(51) Int. Cl. F21K 99/00; F21V 8/00

(52) U.S. Cl. CPC F21K 9/56; F21K 9/52; G02B 6/0008

(57) ABSTRACT

A lighting apparatus substantially as illustrated and described.

### CROSS-REFERENCE TO RELATED APPLICATION

This application claims the benefit of U.S. Provisional Application Ser. No. 62/038,526, filed by Stone on Aug. 18, 2014, entitled “Method and Apparatus for Collimating Light from a Laser-Excited Phosphor Element,” commonly owned with this application and incorporated herein by reference.

### TECHNICAL FIELD

This application is directed, in general, to lighting sources and, more specifically, to lighting sources employing laser-excited phosphor elements.

### BACKGROUND

Increasing demand for more efficient lighting sources has led many industries away from incandescent, arc and induction light sources and into solid state lighting. Solid state lighting has primarily been represented by light emitting diodes due to their long duty cycles and high rate of conversion of electrical energy into light (at about 80% efficiency). LED light sources are not, however, without their drawbacks. First, LEDs are very narrow-band emitters, typically covering a band of some 10 nm at half height of the output curve. This makes emission of full spectrum white light from an LED-only illuminator highly impractical, as doing so would require tens of different-wavelength emitters. Consequently, lighting manufacturers have used combinations of LEDs and phosphors that are excited by the center wavelength of a given color LED to approximate white light. This approach also has its drawbacks, in that the spectral output profile is characterized by a spike at the LED's emission band followed by a broad band of relatively low emission at a lower frequency, then a broad but lower amplitude band (as compared with the LED output) from the secondary phosphor emission, typically representing ¼ to ⅓ of the visible spectrum, which then trails off to near zero emission at the lower visible frequencies, resulting in an approximate “white light” output that is deficient in the green and red bands. So-called “warm white” LED/phosphor chips shift the phosphor output lower in the frequency band, but still exhibit broad gaps of little or no emission in at least two spectral bands.

LEDs also present significant issues in controllability of output light due to the planar configuration of the emitter. Etendue imposes strict requirements upon the size of a collimator necessary to attain a given collimation angle for the collected beam from the emitter. With current available LED output coupled with practical luminaire size constraints, beam collimation is typically limited to no tighter than 8° without significant loss of optical efficiency. This makes LEDs relatively inefficient sources for imaging optical systems and especially for collimating systems such as searchlights and spots.

The solid state alternatives to LEDs are lasers. In the past, LEDs have held a significant cost and efficiency advantage over lasers for general illumination applications. While LEDs typically convert approximately 80% of electrical energy consumed into light, lasers typically converted electricity at a rate of only about 20%. Lasers were also difficult to cool and also exhibit very narrow band emission patterns similar to those of LEDs.

Advances in laser technology have resulted in lasers capable of conversion of electrical energy to light at closer to 60%, comparing favorably with the 80% conversion rate for LEDs. It has also resulted in vastly less expensive laser modules with significantly reduced cooling requirements similar to those for LEDs that have service lives that compare favorably with high-output LEDs. And while still more expensive and less electrically efficient than LEDs, lasers have the advantage have the advantage of being coherent light rather than exhibiting the difficult to collect and control hemispheric dispersion pattern of planar LED emitters. This allows for vastly better control of output light, resulting in optical efficiencies that may be several times better than those for LEDs in highly collimated beams, overcoming cost and electrical conversion efficiency deficiencies relative to LEDs.

In addition to the coherent nature of laser light sources making higher degrees of collimation of output light possible, it also lends itself to combination of multiple emitters of differing chromaticity into a single beam via readily available optical combiners. While LEDs may also be combined via combiners such as a dichroic “x-cube,” efficiency is compromised by the limited ability to collimate the output from the individual emitters. This results in significant portions of the beams from these emitters striking dichroic elements off-axis, thereby limiting the efficiency of the reflectivity of the dichroic elements and resulting in light loss. Coherent lasers do not suffer from this light loss.

The value of combination of heterogeneous emitters into a single beam is the capability to better approximate full-spectrum light. This is especially true if multiple phosphors excited at different wavelengths and emitting in different visible light bands may be incorporated into the system.

Innumerable lighting applications require a high degree of collimation from light sources. These include searchlights, theatrical fixtures, spotlights, cinema lighting. Likewise, innumerable lighting applications require full-spectrum white light (or at least a reasonable approximation thereof). These applications include lighting for television, cinema production and theater, art gallery lighting, etc., where accurate representation of illuminated pigments or full representation of the spectrum for excitement of CCDs is necessary.

This invention utilizes the inherently greater controllability of laser light to allow more efficient collection and downrange projection of light produced by the laser and by phosphors excited thereby. It also allows for the use of multiple laser-phosphor combinations emitting at differing frequencies so as to provide emission of a fuller range of the visible light spectrum.

### SUMMARY

The invention consists of a laser module or modules, coupled via fiber optic cable to a primary optical element such as a lens or holographic diffuser that distributes the coherent laser output into a given dispersion angle which is projected onto a secondary optic comprised of a reflector of such value as to then redirect the light back into a transparent cylinder or capsule coated on one or both surfaces with one or more phosphor coatings. This phosphor element is located at the focal point of a secondary reflector of desired profile relative to the optical system in question (i.e. a paraboloid for a collimating system or an ellipsoid for an imaging system), which then projects the collected light in the desired beam profile, either out through an exit aperture or through additional optical elements and then through an exit aperture.

The most basic embodiment of this design would be comprised of a single laser module directly coupled to the fiber optic cable, which passes through the secondary reflector and to approximately the focal point of that reflector, where it passes through the rearward (relative to the direction of light travel) end of the phosphor-coated capsule. The fiber optic terminates in a lens that distributes the light from the laser in a given dispersion angle (say, 20°) onto an opposing reflector, at the forward end of the phosphor-coated capsule, whose size encompasses the spread of the lensed beam and redirects it evenly back onto and through the capsule and its phosphor coating, to be collected by the large reflector into the desired beam.

Another embodiment of the design could comprise multiple laser modules of differing chromaticity (say, red, green and violet) coupled to separate fiber optic cables terminating in an optical combiner, with a single fiber optic cable exiting the combiner and passing through the vertex of the secondary reflector and terminated with a lens of the desired value, with the terminated fiber optic cable passing through the rearward end of the phosphor-coated capsule such that its dispersed light strikes the primary reflector at the forward end of the capsule as described above, with some of the frequencies of the laser exciting the phosphors and others simple passing through the phosphor coating to the secondary reflector.

Yet another embodiment of the invention would comprise multiple lasers of differing chromaticity as above, but the phosphor-coated capsule would be coated with a phosphor that is excited by one of the laser frequencies on its first surface, while the second surface would be coated with a second phosphor excited by another of the multiple laser frequencies.

### BRIEF DESCRIPTION

Reference is now made to the following descriptions taken in conjunction with the accompanying drawings, in which:

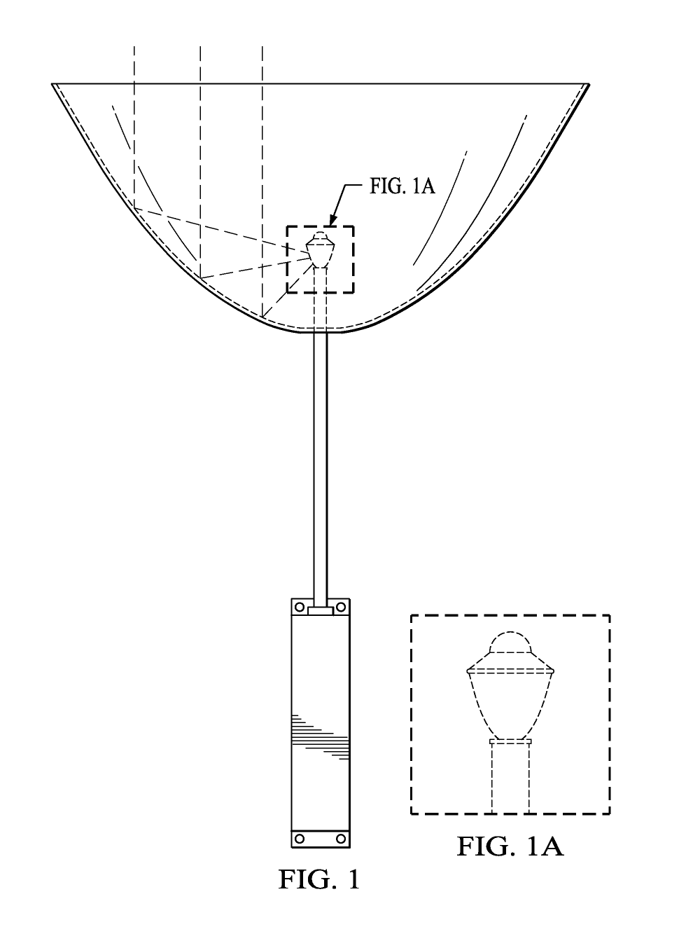

FIGS. 1 and 1A are a diagram of a first embodiment;

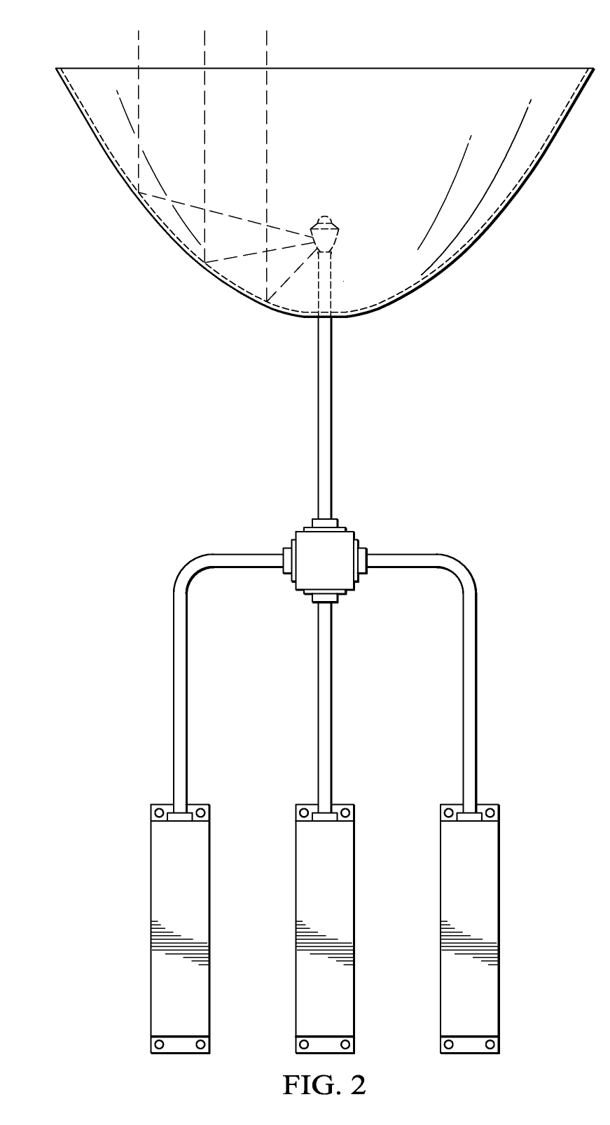

FIG. 2 is a diagram of a second embodiment; and

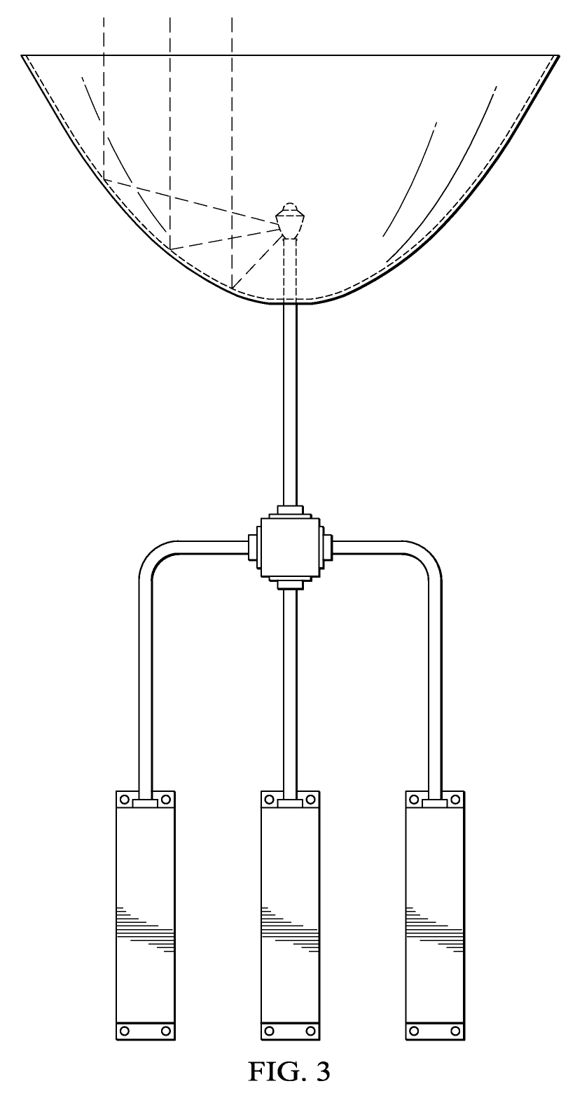

FIG. 3 is a diagram of a third embodiment.

### DETAILED DESCRIPTION

In one embodiment, the invention consists of a laser module [FIG. 1] either directly or indirectly (as via fiber optic cable [FIG. 1]) coupled to a primary optical element [FIG. 1], in the form of a lens, holographic diffuser or other optic designed to disperse light at a specific distribution angle, that disperses the beam from the laser in a predetermined dispersion angle such that its light falls upon a primary curved mirror [FIG. 1] from which it reflects onto a transparent surface formed into a three dimensional shape or capsule [FIG. 1], coated with phosphors that are excited by the frequency of the laser, such that it substantially evenly illuminates that surface, which is located at the focal point [FIG. 1] of an optical system, such as that formed by a secondary parabolic, elliptical or other reflector [FIG. 1] and such additional optical elements as shall be necessary to shape the resultant beam to the desired output. Light from the laser and from the phosphor applied to the surface receiving light reflected by the primary curved mirror which is excited by the laser is captured by the larger secondary reflector and formed into a beam [FIG. 1]. In another embodiment, multiple lasers of the same frequency [FIG. 2] are combined using an optical combiner [FIG. 2] and the sum transmitted through the primary optic and onto the primary reflector which in turn distributes the light substantially evenly, illuminating the capsule and exciting the applied phosphors.

In another embodiment, more than one laser of differing frequencies [FIG. 3] used to illuminate the phosphor capsule are combined using an optical combiner [FIG. 3] and their combined light is transmitted through the primary optic and onto the primary reflector which in turn distributes the light substantially evenly illuminating the capsule and exciting the applied phosphors.

In another embodiment, more than one laser of differing frequencies used to illuminate the phosphor capsule are combined using an optical combiner and their combined light is transmitted through the primary optic and onto the primary reflector which in turn distributes the light substantially evenly illuminating the capsule, on which one phosphor formulation excited a given frequency provided by at least one of the lasers and providing emission in a given frequency band is coated on the first surface of the capsule [FIG. 1A] and on which a second phosphor formulation excited by the frequencies provided by another of the laser frequencies and/or by the emission of the first phosphor formulation and with its own separate given frequency band is coated on the second surface of the capsule [FIG. 1A].

In another embodiment a single laser frequency [FIG. 1] is transmitted through the primary optic [FIG. 1] and onto the primary mirror [FIG. 1] which in turn distributes the light substantially evenly illuminating the capsule [FIG. 1], on which one phosphor formulation excited by the frequency provided the laser and providing emission in a given frequency band is coated on the first surface of the capsule [FIG. 1A] and on which a second phosphor formulation excited by the frequency provided the laser and/or by the emission of the first phosphor formulation and with its own separate given frequency band is coated on the second surface of the capsule [FIG. 1A].

Those skilled in the art to which this application relates will appreciate that other and further additions, deletions, substitutions and modifications may be made to the described embodiments.

What is claimed is:

1. A lighting apparatus substantially as illustrated and described.
